(19) United States
(12) Patent Application Publication
(10) Pub. No.: US 2013/0047412 A1
(43) Pub. Date: Feb. 28, 2013

(54) Lockable Anchor System and Method

(71) Applicant: Eddie Vazquez, Amarillo, TX (US)

(72) Inventor: Eddie Vazquez, Amarillo, TX (US)

(21) Appl. No.: 13/219,670

(22) Filed: Aug. 27, 2011

(51) Int. Cl. F16B 39/10; B23P 11/00

(52) U.S. Cl. 29/525.11; 411/116

(57) ABSTRACT

A lockable anchor system is disclosed comprising a rotary arm anchor. Said rotary arm anchor comprises a stake and an arm. Said stake comprises a first end, a second end, a shaft and a helical portion. Said arm comprises an interior end, an exterior end, one or more horizontal connectors, and an aperture. Said stake and said arm connect by attaching said interior end to said second end of said stake. Said stake is capable penetrating and holding said rotary arm anchor to an anchoring surface. Said interior end and said exterior end of said arm connect with said one or more horizontal connectors. Said aperture comprises an enclosed opening proximate said exterior end of said arm. Said aperture is capable of receiving a lock capable of securing said exterior end to a substantially fixed object and thereby preventing said rotary motion at said interior end by holding said exterior end to said substantially fixed object.

### BACKGROUND

This disclosure relates generally to a lockable anchor system and method.

Lockable anchors have been known for a long time. Securing valuable items being an important objective, many approaches have been introduced to the market.

Dahlstrom, US patent application, publishing number 2006/0060749 A1, discloses a ground anchor system for anchoring a post. Said system comprises a base plate, a housing extending above the base plate, an anchor extending below the base plate, the anchor comprising a tapered helix having a thread encircling a tube which tapers inwardly towards the lower end of the anchor, and a boring tip at the lower end of the anchor. Although Dahlstrom discloses a means of anchoring an object to the ground, it does not provide for a means of locking said system to the ground.

A series of inventions feature a means of inserting an anchor, having a helical portion and a spreading means, into a surface and locking said anchor by prohibiting rotary movement by spreading said spreading means. A US patent application, US 2002/0014570 A1, filed by Jenny features just such a system. Similarly, U.S. Pat. No. 3,332,183 by Ondrejka comprises a plurality of protuberable elements which are forced outward into an active position to prohibit movement to dislodge Ondrejka's anchor from said surface. Likewise, U.S. Pat. No. 3,924,371, issued to Kidwell presents a spreading means comprising a set of flukes discharged from within Kidwell's anchor. All of Ondrejka, Jenny, and Kidwell disclose a means of attaching an anchor to a surface but their approach leaves much to be desired. First, the spreadable means in both cases are moving parts and prone to breaking Neither solution would work in a hard subsurface, such as the ground comprising rocks, wood, or similar, because said spreading means as disclosed require a softer subsurface, such as dirt or sand, in order to expand. Further, these approaches are lacking because they cannot be easily locked and unlocked with a standard tool, such as a padlock, cable lock, or similar. Finally, Kidwell fails to present a helical portion capable of inserting and attaching to said surface as an auger.

Next, a series of inventions feature a planar fin which is installed subsurface with a ground anchor in order to prevent rotary movement. U.S. Pat. No. 3,808,756, issued to Cooper, discloses a ground anchor for securing mobile homes including a planar portion and a U-shaped member interlocking the planar portion of the ground anchor to prevent movement thereof. Likewise, U.S. Pat. No. 5,613,329, issued to Land discloses a ground anchoring including a socket inserted into the ground by driving a bar into the ground. Said socket is provided with a structure to prevent rotation. However, Land's anchor requires that said socket be inserted into the ground with a linear entry. Further, Land's anchor would be easily dug up and discarded since it is inserted into the ground at a shallow angle as disclosed. Similarly, U.S. Pat. No. 5,881,978, issued to Rust, discloses an anchor locking device comprising two parts in a vertical post and a wedge portion; wherein, said wedge portion is coaxially mounted in sliding relationship with said vertical post. Said wedge portion comprising a collar portion having at least one vertical fin for piercing said ground and preventing rotary motion by Rust's anchor. Rust's anchor being in two pieces, however, requires a linear entry of said wedge portion by pressing said wedge portion into said ground. Further, Rust's anchor requires installation of two pieces to be functional. Further, Rust does not disclose a helical portion for easier and more secure installation of said ground anchor. Rust does disclose a sign frame configuration for securing a sign frame to said ground and prevent theft of said sign frame. However, Rust's ground anchor with sign frame does not work with existing sign frames and therefore requires a completely new sign frame and system for use in advertising. For many of the inventions comprising a planar fin lack are difficult to install because planar fins must be pressed into a ground surface and therefore lack the ease of installation of a helical member which screws into a ground surface.

Two patents issued to Sherlock present two ground anchors for securing items at a beach. U.S. Pat. No. 5,501,086 discloses a device comprising two rods comprising a circular blade at one end and an opening at a second end; wherein a bar is attached through the second ends of said rods, said bar is secured with a chain, and a means of securing both ends of said chain (disclosing a pad lock as said means of securing). However, Sherlock '086 is very, very specific in his claims as to how his device is to be made (requiring they be about 30 inches, for example). Further, said circular blade, as disclosed, is not likely capable of penetrating and digging in a harder surface than sand. On one hand, Sherlock '086 is not well suited for use other than at a beach. On the other hand, Sherlock '086 does disclose an innovation of inserting two helical members into the ground and securing said members to one another in order to prevent rotary movement. However, Sherlock does not anticipate using his device in a configuration requiring one rod (rather than two), because his embodiment does not facilitate such as use. In his second patent, U.S. Pat. No. 6,032,498, Sherlock discloses an auger comprising two bars coupled to one another with a non-detachable joint; wherein, a second bar comprises a spiral blade for penetrating a ground surface. Said non-detachable joint allows said bars to move relative to one another and is a required limitation in Sherlock '498. However, Sherlock '498 leaves much to be desired. First, like '086, it is designed for use on the beach in loosely packed surfaces such as sand. It discloses a circular blade, but does not anticipate use in harder surfaces such as rocky soil, wood, rock, stone, etc. Further, said non-detachable joint, a required feature, is prone to breaking and deterioration and will likely be a weak point when using said first bar to screw said second bar into a subsurface.

As applying to all prior art references, it can be said that none are well suited for use in a surface other than dirt or sand. They can be generally referred to as ground anchors, but they miss the opportunity to create a lockable anchor capable of attaching to surfaces other than the ground. For example, it could be useful to create a lockable anchor capable of attaching to a wall (such as sheetrock and/or studs thereunder), a ceiling, a fence, or similar. Further, improvements are necessary to use less costly materials, some capable of rapid manufacture (such as bent wire), to create an anchor system. Further, creating an anchor system capable of being used with one ground anchor (rather than requiring two) would be helpful. Likewise, an anchor system for attaching to existing fixed objects (such as advertisements or real estate signs), rather than redesign the entire fixed object, would be valuable. It is further clear, when referring to the existing art, that none comprise a locking system built directly into the anchor system.

None of the above inventions and patents, taken either singularly or in combination, is seen to describe the instant disclosure as claimed. Accordingly, an improved lockable anchor system and method would be advantageous.

### SUMMARY

A lockable anchor system and method are disclosed. First, a lockable anchor system is disclosed comprising a rotary arm anchor. Said rotary arm anchor comprises a stake and an arm. Said stake comprises a first end, a second end, a shaft and a helical portion. Said arm comprises an interior end, an exterior end, one or more horizontal connectors, and an aperture. Said stake and said arm connect by attaching said interior end to said second end of said stake. Said stake is capable penetrating and holding said rotary arm anchor to an anchoring surface. Said interior end and said exterior end of said arm connect with said one or more horizontal connectors. Said aperture comprises an enclosed opening proximate said exterior end of said arm. Said aperture is capable of receiving a lock capable of securing said exterior end to a substantially fixed object and thereby preventing said rotary motion at said interior end by holding said exterior end to said substantially fixed object. Next, a lockable anchor method is disclosed. Said method comprising: inserting a stake of a rotary arm anchor having said stake and an arm into an anchoring surface; holding said rotary arm anchor to said anchoring surface with a helical portion of said stake having a shaft and a helical portion; receiving a lock near an exterior end of said arm having an interior end and said exterior end; attaching said stake to said arm at a second end of said stake and said interior end of said arm; and preventing a rotary motion at said interior end by holding said exterior end to a fixed object with said lock. Wherein, inserting said stake into said anchoring surface comprises aligning a first end of stake with an anchoring location in said anchoring surface, pressing said first end into said anchoring surface, and rotating said rotary arm anchor about a rotary axis with a rotary motion.

### BRIEF DESCRIPTION OF THE DRAWINGS

FIGS. 1A, 1B, and 1C illustrate a top view, a right side view, and a front view of a ground anchor, respectively.

FIGS. 2A and 2B illustrate a top and front view of a first anchor and a second anchor aligned in a dual anchor locking position.

FIG. 3 illustrates first anchor and second anchor aligned in said dual anchor locking position and inserted into an anchoring surface.

FIGS. 4A, 4B, and 4C illustrates a detailed view, a front view, and a side view of first anchor and second anchor in said dual anchor locking position and secured with a lock.

FIGS. 5A, 5B, and 5C illustrate a front view, top view, and overview of an alternative anchor and second anchor secured to one another.

FIG. 6 illustrates an advertisement.

FIGS. 7A, 7B, 7C and 7D illustrate a front view, side view, detailed side view, and overview of advertisement, first anchor, and lock in a single anchor position.

FIGS. 7E and 7F illustrate two overviews of first anchor secured to a lock bracket attached to crossbar.

FIGS. 8A, 8B, and 8C illustrate a top view, side view, and front view of a helical anchor.

FIGS. 9A and 9B illustrate a top and side view of a first helical anchor and a second helical anchor aligned in said dual anchor locking position.

FIGS. 10A and 10B illustrate first helical anchor and second helical anchor aligned in said dual anchor locking position, inserted into said anchoring surface, and secured with lock.

FIGS. 11A and 11B illustrate a front view a long arm wall anchor and a long arm wall anchor.

FIGS. 12A, 12B, 13C, and 12D illustrate a front view, first side view, second side view, and top view of a short arm wall anchor.

FIGS. 13A and 13B illustrate a front and side view of long arm wall anchor and short arm wall anchor aligned in said dual anchor locking position.

FIGS. 14A, 14B and 14C illustrate a front view, left view and overview of long arm wall anchor, short arm wall anchor, and lock in said dual anchor locking position and locked with lock.

### DETAILED DESCRIPTION

Described herein is a lockable anchor system and method. The following description is presented to enable any person skilled in the art to make and use the invention as claimed and is provided in the context of the particular examples discussed below, variations of which will be readily apparent to those skilled in the art. In the interest of clarity, not all features of an actual implementation are described in this specification. It will be appreciated that in the development of any such actual implementation (as in any development project), design decisions must be made to achieve the designers' specific goals (e.g., compliance with system- and business-related constraints), and that these goals will vary from one implementation to another. It will also be appreciated that such development effort might be complex and time-consuming, but would nevertheless be a routine undertaking for those of ordinary skill in the field of the appropriate art having the benefit of this disclosure. Accordingly, the claims appended hereto are not intended to be limited by the disclosed embodiments, but are to be accorded their widest scope consistent with the principles and features disclosed herein.

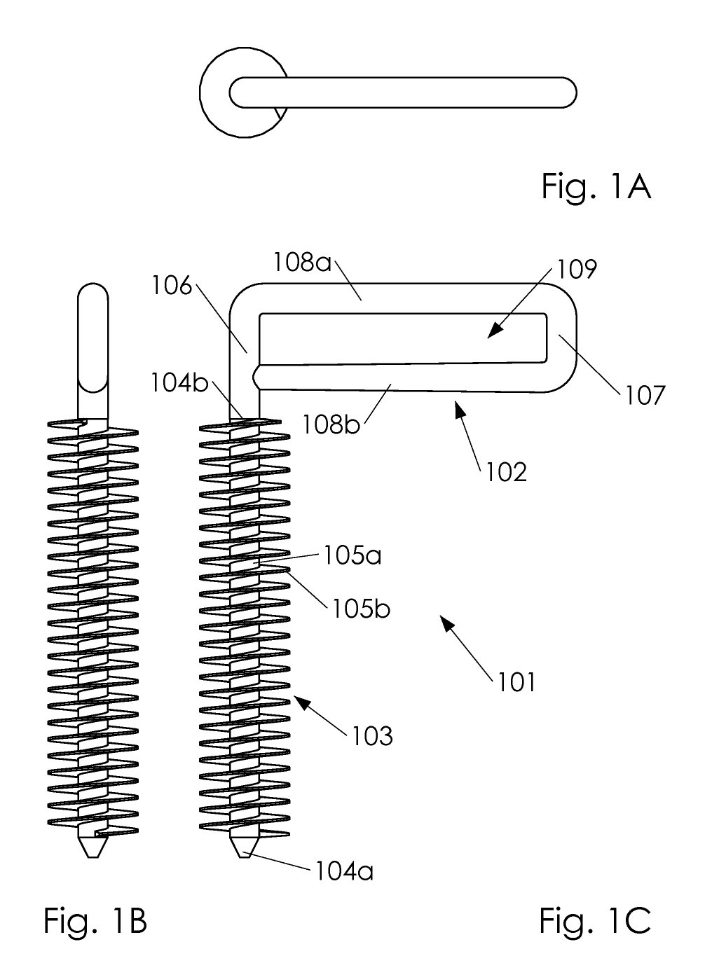

FIGS. 1A, 1B, and 1C illustrate a top view, a right side view, and a front view of a ground anchor 101, respectively. In one embodiment, said lockable anchor system and method can comprise one or more rotary arm anchors. In one embodiment, said rotary arm anchor can comprise ground anchor 101. Ground anchor 101 can comprise an arm 102 and a stake 103. In one embodiment, stake 103 can comprise a first end 104a, second end 104b, a shaft 105a, and a helical portion 105b. In one embodiment, helical portion 105b can comprise a raised helical thread running around shaft 105a. In one embodiment, stake 103 can comprise a threaded shaft. Arm 102 can comprise an interior end 106, an exterior end 107, one or more horizontal connectors 108, and an aperture 109. Horizontal connectors 108 can comprise a first horizontal connector 108a, and a second horizontal connector 108b. In one embodiment, said aperture 109 can comprise a substantially enclosed loop created by connecting interior end 106 to first horizontal connector 108a, first horizontal connector 108a to exterior end 107, exterior end 107 to second horizontal connector 108b, and second horizontal connector 108b back to interior end 106, as shown in FIGS. 1A, 1B, and 1C. In one embodiment, second horizontal connector 108b can connect to interior end 106 by a spot weld. In another embodiment, aperture 109 can comprise any substantially enclosed loop proximate to exterior end 107. In one embodiment, stake 103 can attach to arm 102 by attaching interior end 106 to second end 104b. In one embodiment, first end 104a can taper in to form a sharpened point at first end 104a. In one embodiment, arm 102 can comprise a single piece of bent metal. In one embodiment, second horizontal connector 108b can connect to interior end 106 with a spot weld.

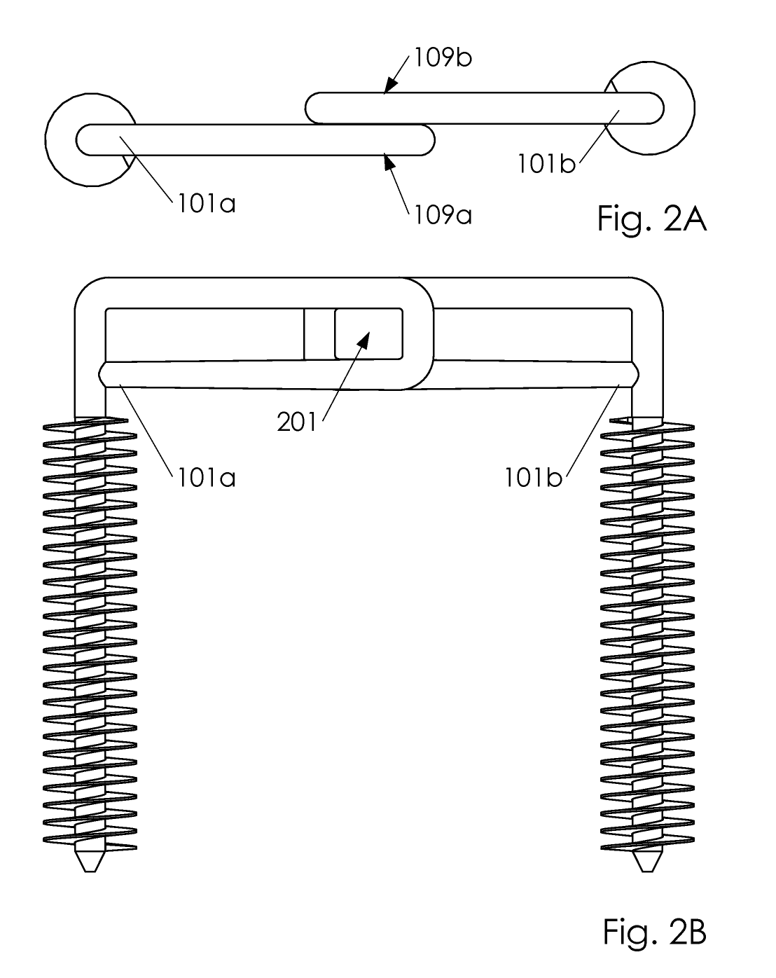

FIGS. 2A and 2B illustrate a top and front view of a first anchor 101a and a second anchor 101b aligned in a dual anchor locking position. In one embodiment, said lockable anchor system and method can comprise first anchor 101a and second anchor 101b. In one embodiment, lockable anchor system and method can comprise first anchor 101a capable of receiving a lock capable of securing exterior end 107 to a substantially fixed object. In one embodiment, said fixed object can comprise second anchor 101b. In one embodiment, said lockable anchor system and method can comprise locking first anchor 101a to second anchor 101b. First anchor 101a can comprise a first anchor aperture 109a. Second anchor 101b can comprise a second anchor aperture 109b. Lockable anchor system and method can comprise a dual anchor locking position comprising aligning multiple rotary arm anchors in a position capable of receiving a locking means to bind said multiple rotary arm anchors to one another. For example, in one embodiment, said dual anchor locking position can comprise aligning first anchor aperture 109a and second anchor aperture 109b to create an aligned aperture 201 at the cross section of first aperture 109a and second aperture 109b, capable of receiving a locking means to bind first anchor 101a to second anchor 101b. In one embodiment, said lockable anchor system and method can comprise a plurality of rotary arm anchors attached to first aperture 109a.

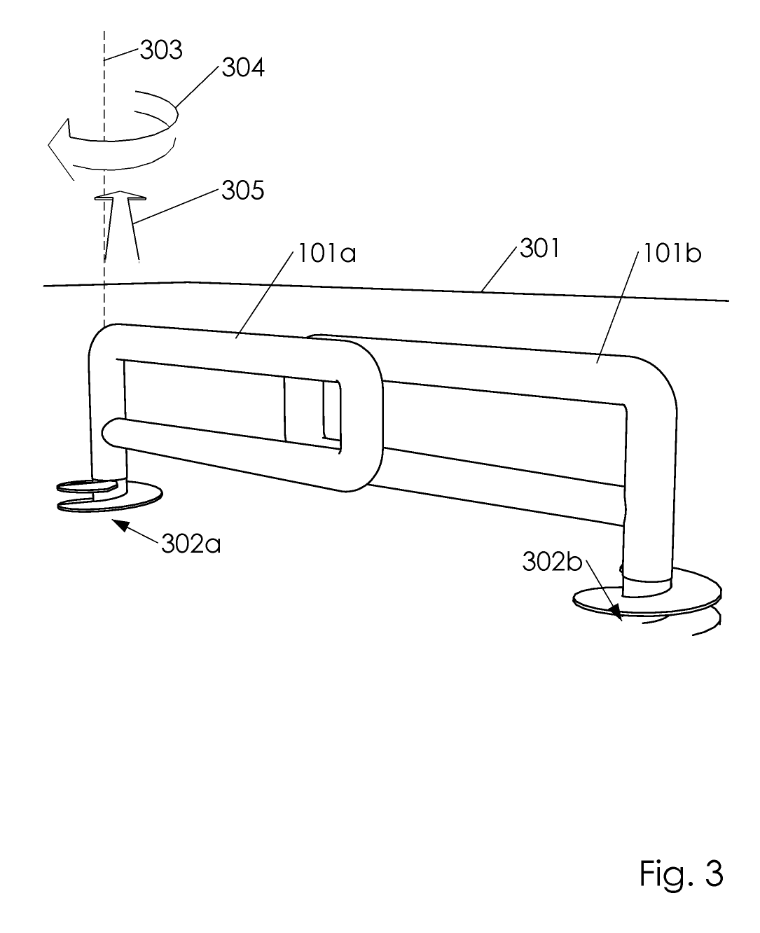

FIG. 3 illustrates first anchor 101a and second anchor 101b aligned in said dual anchor locking position and inserted into an anchoring surface 301. In one embodiment, lockable anchor system and method can comprise attaching one or more ground anchors 101 to anchoring surface 301. In one embodiment, attaching said one or more ground anchors 101 to anchoring surface 301 can comprise inserting each of stakes 103 into an anchoring location 302 in anchoring surface 301. For example, in one embodiment, first anchor 101a can insert at an anchoring location 302a, and second anchor 101b can insert at anchoring location 302b.

Anchoring surface 301 can comprise an organic ground surface (such as grass and/or dirt), a wall, a ceiling, a fence, or similar. In one embodiment, said lockable anchor system and method can comprise penetrating and holding one or more ground anchors 101 in anchoring surface 301. In one embodiment, penetrating and holding ground anchor 101 in anchoring surface 301 can comprise aligning first end 104a of stake 103 with anchoring location 302, pressing first end 104a into anchoring surface 301, rotating ground anchor 101 about a rotary axis 303 with a rotary motion 304, and resisting a linear force 305 by holding a portion of anchoring surface 301 between shaft 105a and helical portion 105b. In one embodiment, linear force 305 can comprise any force attempting to pull ground anchor 101 out of anchoring surface 301 without applying rotary motion 304.

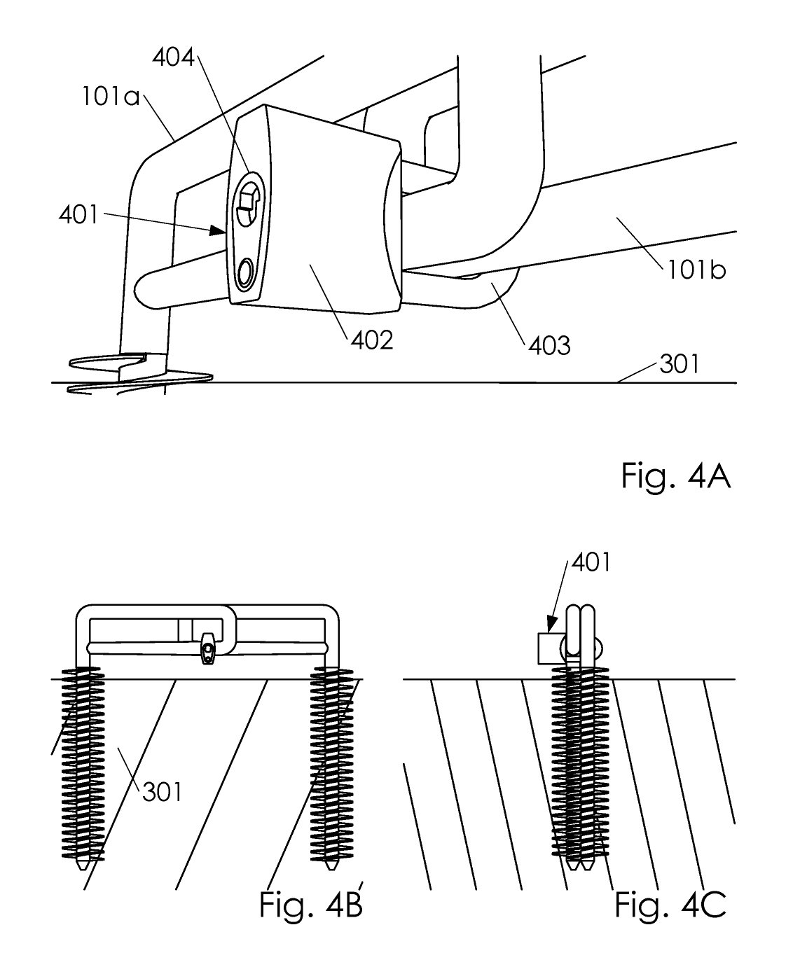

FIGS. 4A, 4B, and 4C illustrates a detailed view, a front view, and a side view of first anchor 101a and second anchor 101b in said dual anchor locking position and secured with a lock 401. In one embodiment, said lockable anchor system and method can comprise locking two or more ground anchors 101 to one another with lock 401. Lock 401 can comprise a body 402, a shackle 403, and a locking mechanism 404. In one embodiment, shackle 403 can comprise a U-shaped shackle as is common among padlocks. In one embodiment, first anchor 101a can be secured to second anchor 101b by locking shackle 403 through aligned aperture 201. In one embodiment, rotary motion 304 can be restricted by securing exterior end 107 to a substantially fixed object. As discussed infra, in one embodiment, said fixed object can comprise second anchor 101b or a plurality of ground anchors 101. In one embodiment, said rotary arm anchor can be secured to anchoring surface 301 by restricting both rotary motion 304 is and linear force 305. In one embodiment, lock 401 can comprise a padlock, as illustrated in FIGS. 4A-4C. In another embodiment, lock 401 can comprise a cable lock; wherein a portion of said cable lock can be fed through aligned aperture 201 and another portion can be secured to another object.

In one embodiment, said lockable anchor system and method can comprise: inserting stake 103 into anchoring surface 301; holding said rotary arm anchor to anchoring surface 301 with shaft 105a and helical portion 105b; receiving lock 401 near exterior end 107; preventing rotary motion 304 at interior end 106 by holding exterior end 107 to a fixed object with lock 401; wherein, inserting stake 103 into anchoring surface 301 comprises aligning first end 104a with anchoring location 302, pressing first end 104a into anchoring surface 301, and rotating said rotary arm anchor about rotary axis 303 with rotary motion 304.

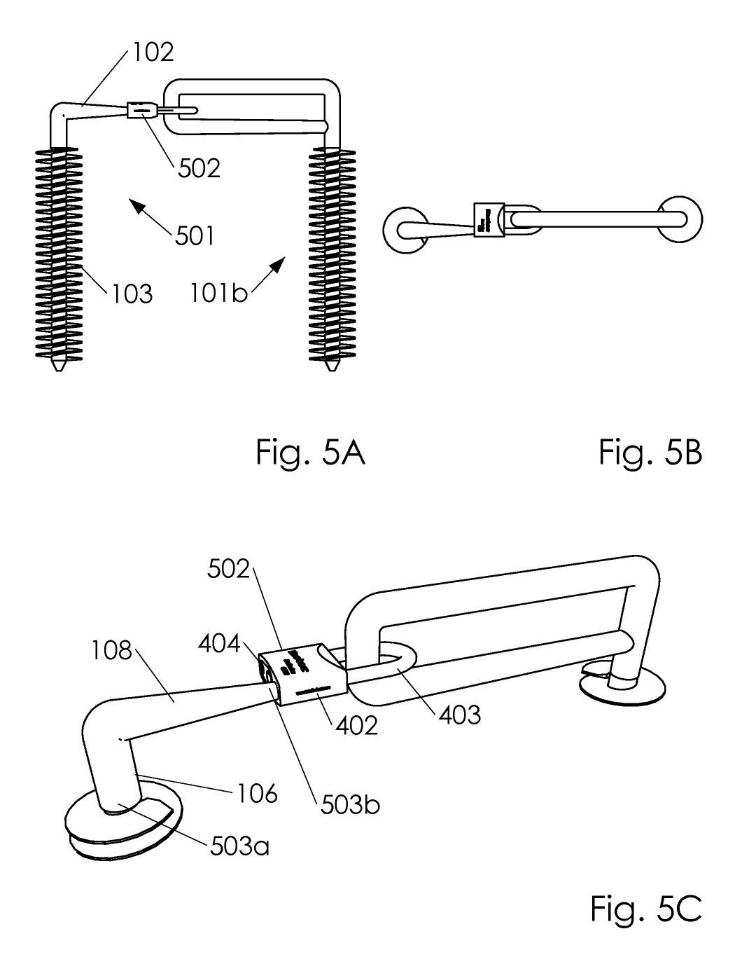

FIGS. 5A, 5B, and 5C illustrate a front view, top view, and overview of an alternative anchor 501 and second anchor 101b secured to one another. In one embodiment, said rotary arm anchor can comprise an integrated lock 502. In one embodiment, alternative anchor 501 can comprise integrated lock 502. In one embodiment, integrated lock 502 can comprise body 402, shackle 403, and locking mechanism 404. In one embodiment, arm 102 can comprise a first end 503a and a second end 503b. In one embodiment, first end 503a can attach to second end 104b, and second end 503b can attach to integrated lock 502. In one embodiment, interior end 106 can attach to second end 104b and horizontal connectors 108, and horizontal connectors 108 can attach to interior end 106 and integrated lock 502. In one embodiment, securing alternative anchor 501 to a fixed object can comprise aligning integrated lock 502 with said fixed object, opening shackle 403, wrapping shackle 403 around said fixed object, and locking integrated lock 502 to said fixed object. In one embodiment, said fixed object can comprise another rotary arm anchor, such as second anchor 101b.

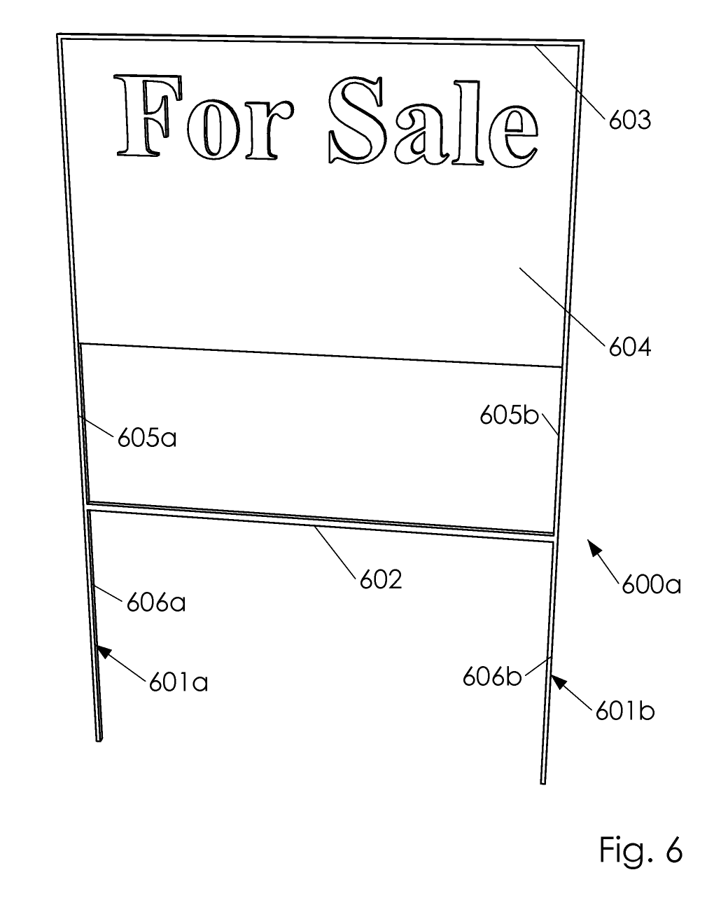

FIG. 6 illustrates an advertisement 600. In one embodiment, advertisement 600 can comprise a yard sign 600a, as illustrated in FIG. 6. In one embodiment, yard sign 600a can comprise a for sale real estate for sale sign. Advertisement 600 can comprise one or more legs 601, a crossbar 602, a top crossbar 603, and a sign 604. Legs 601 can comprise a first leg 601a and a second leg 601b. In one embodiment, legs 601 can be substantially parallel and capable of insertion into anchoring surface 301. In one embodiment, crossbar 602 and top crossbar 603 can be substantially parallel to one another and substantially perpendicular to legs 601. In one embodiment, sign 604 can be attached to a portion of legs 601 and top crossbar 603. In one embodiment, each of legs 601 can each comprise an upper portion 605 and a lower portion 606.

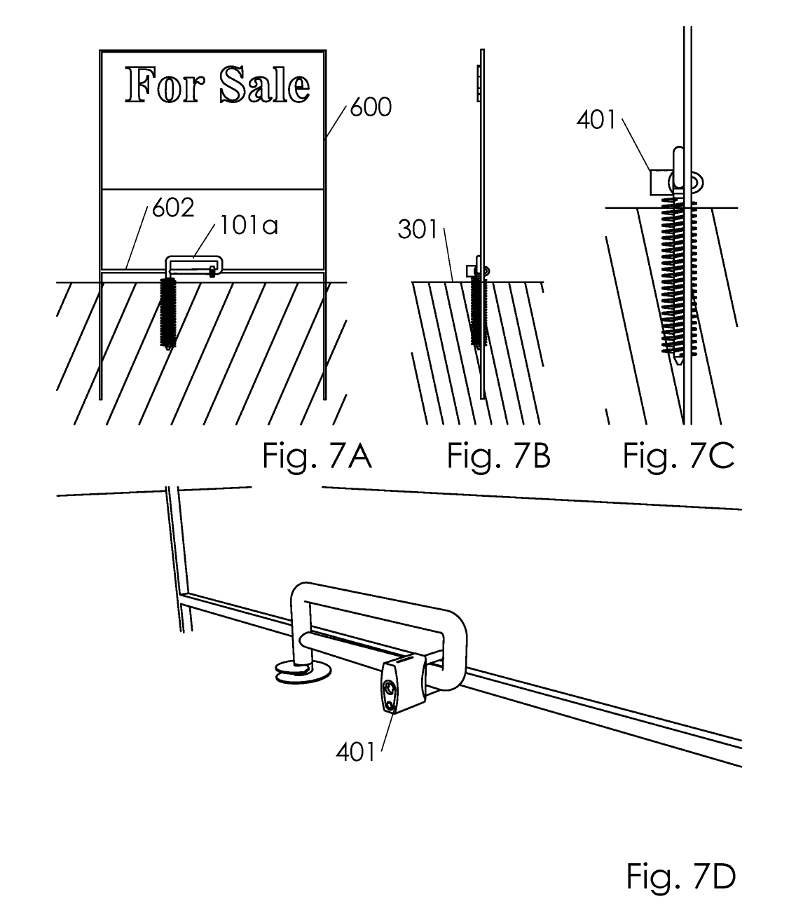

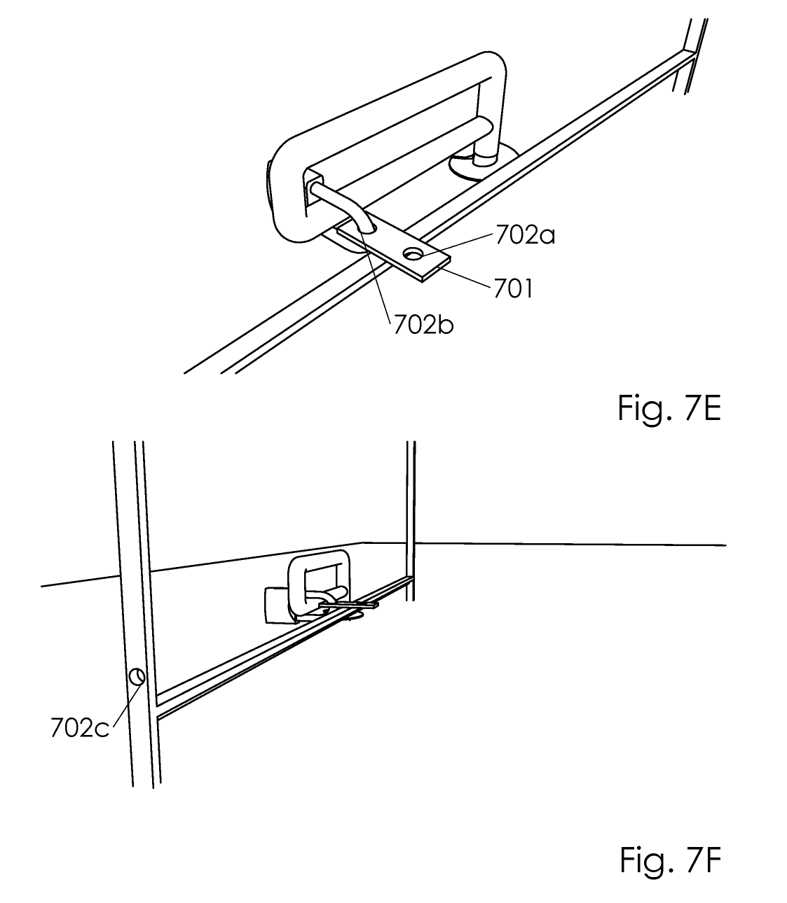

FIGS. 7A, 7B, 7C and 7D illustrate a front view, side view, detailed side view, and overview of advertisement 600, first anchor 101a, and lock 401 in a single anchor position. In one embodiment, said lockable anchor system and method can comprise said single anchor position. In one embodiment, said single anchor position can comprise a portion of said rotating arm anchor and a portion of said fixed object attached to anchoring surface 301, and said rotation arm anchor attached to said fixed object to restrict rotary motion 304. In one embodiment, said fixed object can comprise advertisement 600, such as yard sign 600a or a real estate for sale sign. In one embodiment, first anchor 101a can secure advertisement 600 by inserting first anchor 101a into anchoring surface 301, inserting advertisement 600 into anchoring surface 301 to a depth wherein a portion of crossbar 602 aligns with a portion of arm 102, and locking arm 102 to crossbar 602 with lock 401. In one embodiment, advertisement 600 can comprise any or one or more target object capable of attaching to anchoring surface 301 and being secured to first anchor 101a.

FIGS. 7E and 7F illustrate two overviews of first anchor 101a secured to a lock bracket 701 attached to crossbar 602. In one embodiment, advertisement 600 can further comprise lock bracket 701 and one or more lock apertures 702. In one embodiment, lock bracket 701 can attach to crossbar 602, as illustrated in FIGS. 7E and 7F. In one embodiment, lock bracket 701 can comprise a lock aperture 702a and a lock aperture 702b. In one embodiment, shackle 403 can insert through lock aperture 702 and lock back to body 402. In one embodiment, first anchor 101a can attach to advertisement 600 by securing arm 102 to lock bracket 701 with shackle 403 locked around and through aperture 109a and lock aperture 702. In one embodiment, lock aperture 702 can comprise a lock aperture 702c in a portion of advertisement 600; wherein, lock 401 can attach through lock aperture 702c without using lock bracket 701.

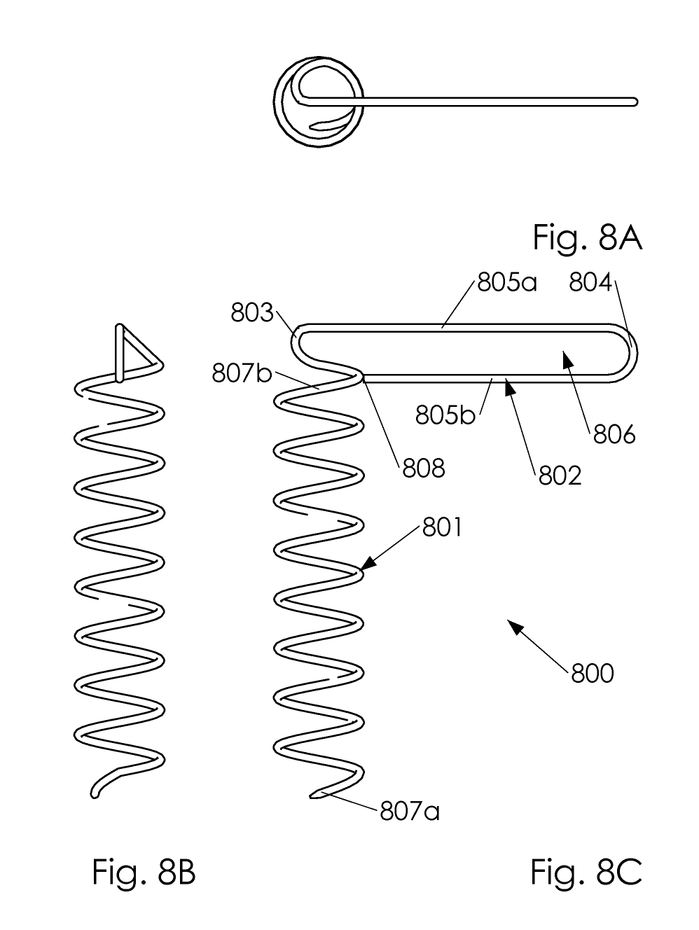

FIGS. 8A, 8B, and 8C illustrate a top view, side view, and front view of a helical anchor 800. In one embodiment, said rotary arm anchor can comprise helical anchor 800. In one embodiment, helical anchor 800 can comprise on piece of bent medal comprising a stake 801 and arm 802. In one embodiment, stake 801 can comprise a corkscrew shaped portion of helical anchor 800. In one embodiment, arm 802 can comprise a horizontal portion of helical anchor 800 extending substantially perpendicular to stake 801. Arm 802 can comprise an interior end 803, an exterior end 804, and one or more horizontal connectors 805. In one embodiment, an aperture 806 can comprise an opening between interior end 803, exterior end 804, and horizontal connectors 805. In one embodiment, stake 801 can comprise a first end 807a and a second end 807b. In one embodiment, first end 807a can comprise a sharpened point for penetrating anchoring surface 301. In one embodiment, helical anchor 800 can comprise a material strong enough to withstand rotary motion 304 applied to secure helical anchor 800 to anchoring surface 301. In one embodiment, helical anchor 800 can comprise many portions of a single piece of bent metal such as: stake 801 bent into a helical spiral, bending up into interior end 803, straightening out into first horizontal connector 805a, curving downwardly into exterior end 804, straightening out into second horizontal connector 805b and progressing substantially parallel to first horizontal connector 805a back toward stake 801, and finally connecting near to interior end 803. In one embodiment, second horizontal connector 805b can connect to interior end 803 by a weld 808.

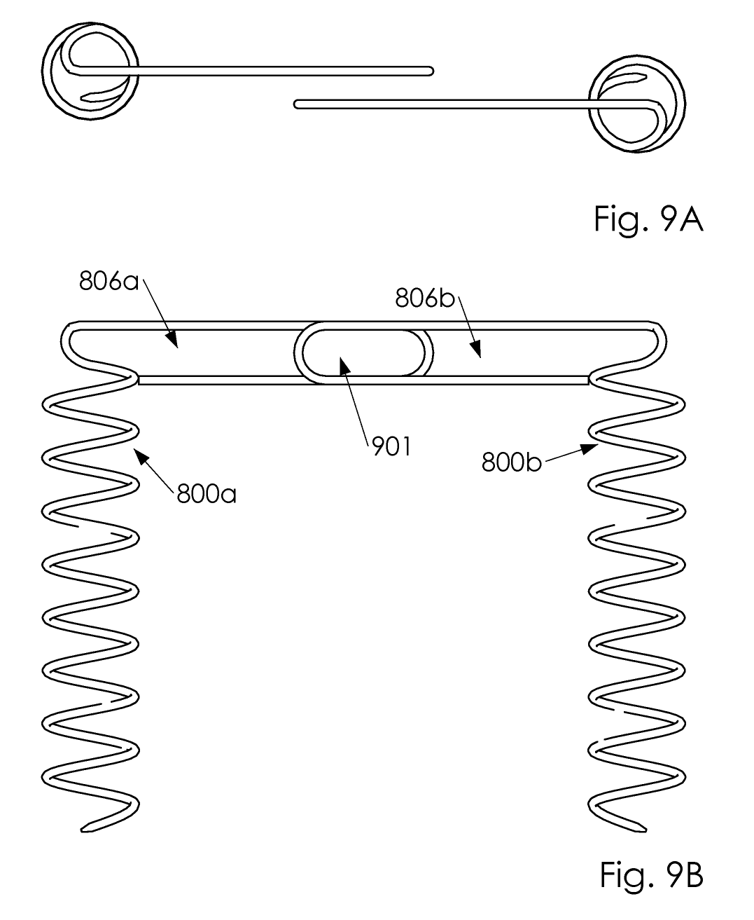

FIGS. 9A and 9B illustrate a top and side view of a first helical anchor 800a and a second helical anchor 800b aligned in said dual anchor locking position. In one embodiment, said lockable anchor system and method can comprise a plurality of helical anchor 800. Helical anchor 800 can comprise first helical anchor 800a and second helical anchor 800b. Similar to ground anchor 101, in one embodiment, first helical anchor 800a and second helical anchor 800b can be arranged into said dual anchor locking position, by aligning a portion of an aperture 806a and an aperture 806b; wherein, an overlapping area of aperture 806a and aperture 806b is a aligned aperture 901.

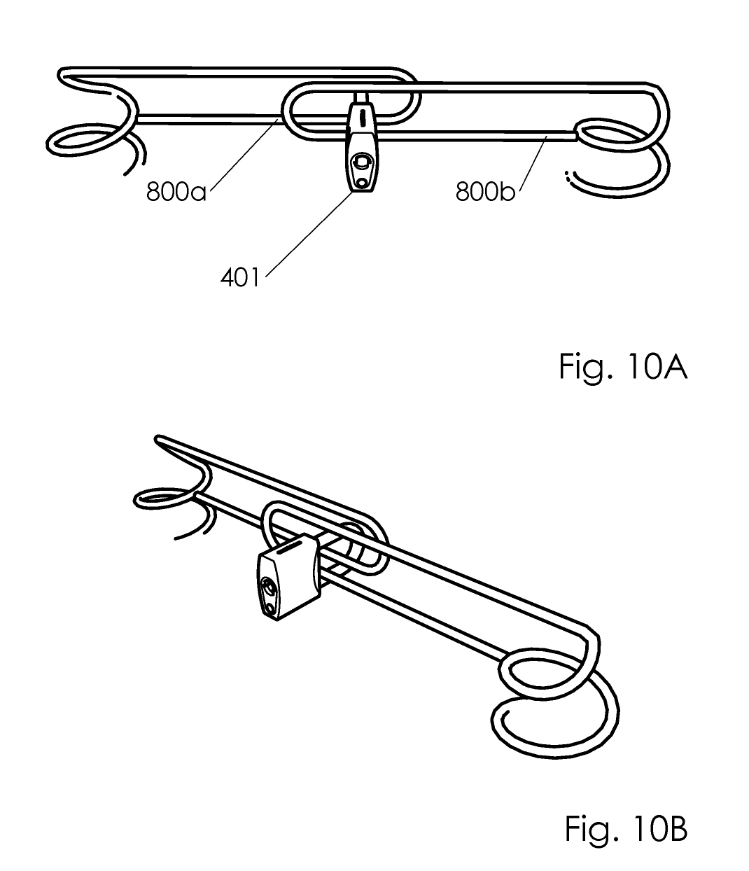

FIGS. 10A and 10B illustrate first helical anchor 800a and second helical anchor 800b aligned in said dual anchor locking position, inserted into said anchoring surface 301, and secured with lock 401. Similar to configurations with ground anchor 101, in one embodiment, a plurality of helical anchors 800 can be secured to one another with lock 401, as illustrated in FIGS. 10A and 10B. Accordingly, it is understood that the use of “rotary arm anchor” encompasses all of ground anchor 101, alternative anchor 501, and helical anchor 800.

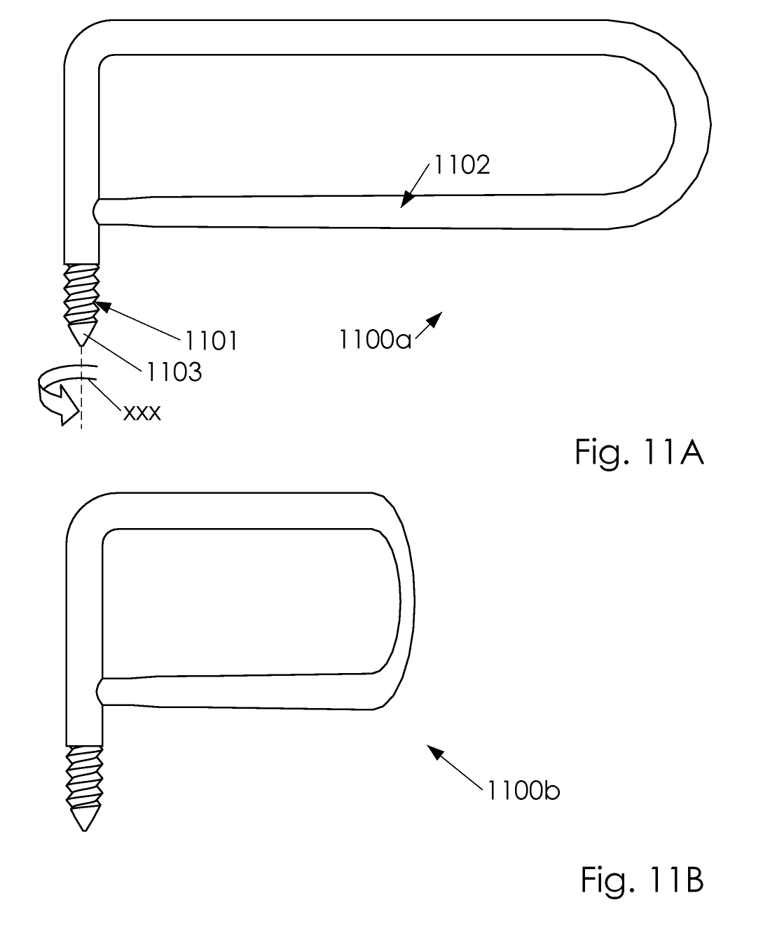

FIGS. 11A and 11B illustrate a front view a long arm wall anchor 1100a and a long arm wall anchor 1100b. In one embodiment, said rotary arm anchor can comprise a long arm wall anchor 1100. Long arm wall anchor 1100 can comprise a stake 1101 and an arm 1102. In one embodiment, long arm wall anchor 1100 can be well suited for attaching to a hardened anchoring surface 301, such as a wall, a ceiling, a fence, or similar. For example, in one embodiment, stake 1101 can comprise a sharpened point at a first end 1103a for penetrating anchoring surface 301. In another embodiment, long arm wall anchor 1100 can comprise a hardened metal capable of withstanding substantial torque as arm 1102 is rotated to insert long arm wall anchor 1100 into anchoring surface 301. Long arm wall anchor 1100 can comprise long arm wall anchor 1100a and long arm wall anchor 1100b. Long arm wall anchor 1100a and long arm wall anchor 1100b are provided to illustrate that a wide range of lengths of arm 1102 can be encompassed by long arm wall anchor 1100.

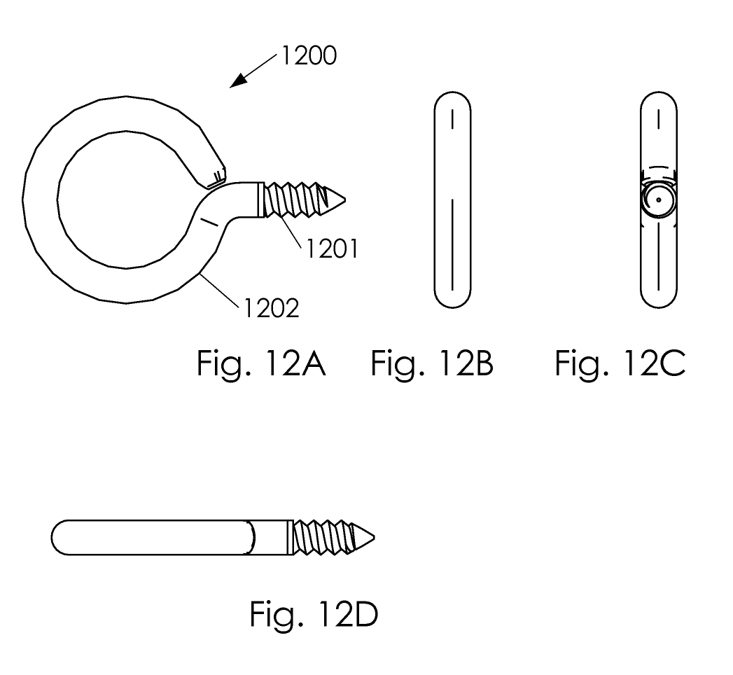

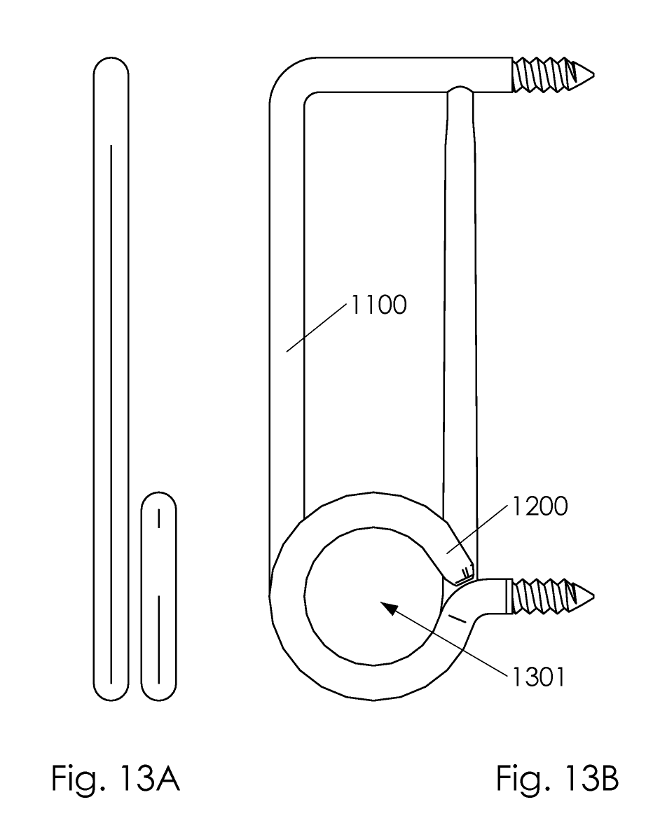

FIGS. 12A, 12B, 13C, and 12D illustrate a front view, first side view, second side view, and top view of a short arm wall anchor 1200. In one embodiment, said rotary arm anchor can comprise short arm wall anchor 1200. Short arm wall anchor 1200 can comprise a stake 1201 and an arm 1202. In one embodiment, stake 1201 can function in a similar manner to stake 1101, being capable of securing short arm wall anchor 1200 a hardened anchoring surface 301. In one embodiment, arm 1202 can comprise an eye hook. That is, in one embodiment, arm 1202 can connect to stake 1201 at one end, bend out and into a circular shape having an opening therein (the “eye”), and bend around toward its starting point. In one embodiment, arm 1202 can be welded back to form an enclosed loop around said eye. In another embodiment, arm 1202 can wrap substantially around in a circle but lack a spot weld, as is illustrated in FIGS. 12A-12D.

FIGS. 13A and 13B illustrate a front and side view of long arm wall anchor 1100 and short arm wall anchor 1200 aligned in said dual anchor locking position. In one embodiment, long arm wall anchor 1100, long arm wall anchor 1100a, long arm wall anchor 1100b, and short arm wall anchor 1200 can be configured with one another to form said dual anchor locking position. In any such embodiment, an aligned aperture 1301 can result from aligning a plurality of apertures.

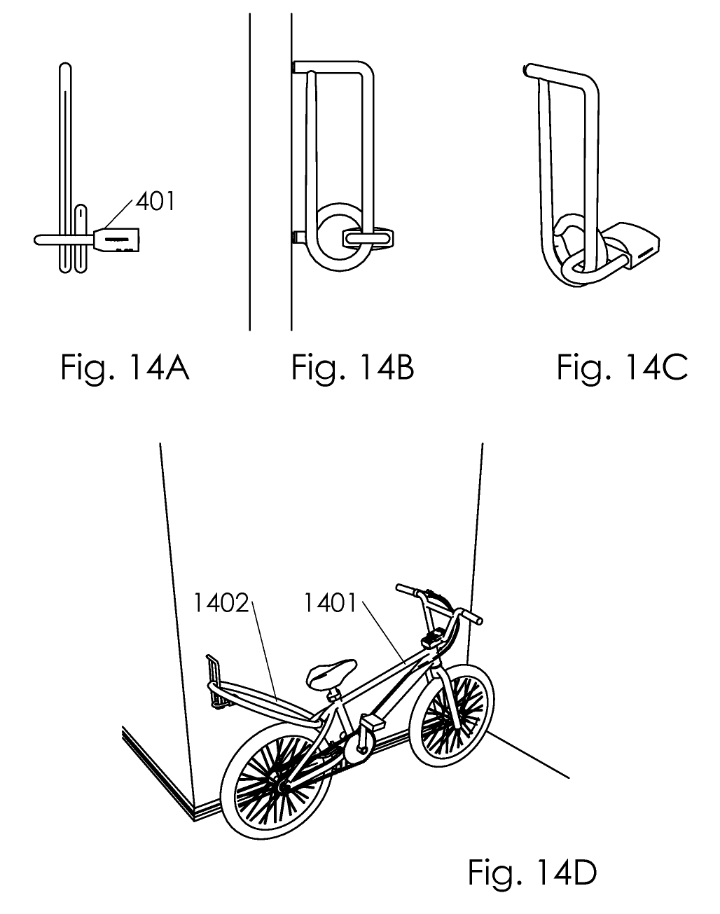

FIGS. 14A, 14B and 14C illustrate a front view, left view and overview of long arm wall anchor 1100, short arm wall anchor 1200, and lock 401 in said dual anchor locking position and locked with lock 401. In one embodiment, a plurality of rotary arm anchors can be used to create an anchoring point with minimal effort and damage to an environment. For example, in one embodiment, two said rotary arm anchors can be secured to a wall, aligned in said dual anchor locking position, and locked together with lock 401 to create said anchoring point. In one embodiment, said anchoring point can be used to lock other objects to said lockable anchor system and method. For example, FIG. 14D illustrates an overview of securing a bicycle 1401 with said lockable anchor system and method. In one embodiment, a cable lock 1402 can attach bicycle 1401 to said lockable anchor system and method by threading a portion of cable lock 1402 through said lockable anchor system and method, threading another portion of cable lock 1402 through bicycle 1401, and locking cable lock 1402. In another embodiment, lock 401 can be removed from said lockable anchor system and method and cable lock 1402 can be threaded through aligned aperture 1301 and a portion of bicycle 1401 before being locked.

Various changes in the details of the illustrated operational methods are possible without departing from the scope of the following claims. Some embodiments may combine the activities described herein as being separate steps. Similarly, one or more of the described steps may be omitted, depending upon the specific operational environment the method is being implemented in. It is to be understood that the above description is intended to be illustrative, and not restrictive. For example, the above-described embodiments may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.”

1. A lockable anchor system comprising:
a rotary arm anchor having a stake and an arm;
said stake comprises a first end, a second end, a shaft and a helical portion; and,
said arm comprises an interior end, an exterior end, one or more horizontal connectors, and an aperture; wherein,
said stake and said arm connect by attaching said interior end to said second end of said stake;
said stake is capable penetrating and holding said rotary arm anchor to an anchoring surface;
said interior end and said exterior end of said arm connect with said one or more horizontal connectors;
said aperture comprises an enclosed opening proximate said exterior end of said arm; and
said aperture is capable of receiving a lock capable of securing said exterior end to a substantially fixed object and thereby preventing a rotary motion at said interior end by holding said exterior end to said substantially fixed object.

2. The lockable anchor system of claim 1 wherein said fixed object comprise an eye hook.

3. The lockable anchor system of claim 1 wherein said fixed object comprise a second rotary arm anchor; wherein a first rotary arm anchor attaches to said second rotary arm anchor.

4. The lockable anchor system of claim 3 wherein said first rotary arm anchor and said second rotary arm anchor attach to one another by
aligning said first rotary arm anchor and said second rotary arm anchor and
locking an aperture of said first rotary arm anchor to an aperture of said second rotary arm anchor with a locking means.

5. The lockable anchor system of claim 1 wherein said fixed object comprise a plurality of rotary arm anchors; wherein a first rotary arm anchor attaches to said plurality of rotary arm anchors.

6. The lockable anchor system of claim 1 wherein said lock is a padlock.

7. The lockable anchor system of claim 1 wherein said lock is a cable lock.

8. The lockable anchor system of claim 1 wherein penetrating and holding said rotary arm anchor to an anchoring surface comprises:
aligning said first end of said stake with an anchoring location,
pressing said first end into said anchoring surface,
rotating said rotary arm anchor with a rotary motion, and
resisting a linear force on said stake by holding a portion of said anchoring surface between said shaft and said helical portion.

9. The lockable anchor system of claim 1 wherein said stake comprises a threaded shaft.

10. The lockable anchor system of claim 1 said aperture comprises an opening between said interior end, said exterior end, and said one or more horizontal connectors.

11. The lockable anchor system of claim 1 wherein said arm further comprises an integrated lock having a body, a shackle, and a locking mechanism; wherein, said integrated lock is capable of locking said lock to said fixed object.

12. The lockable anchor system of claim 1 wherein said anchoring surface comprises an organic ground surface.

13. The lockable anchor system of claim 1 wherein said anchoring surface comprises a wall.

14. The lockable anchor system of claim 1 wherein said anchoring surface comprises a ceiling.

15. The lockable anchor system of claim 1 wherein said anchoring surface comprises a fence.

16. The lockable anchor system of claim 1 wherein a portion of said fixed object is also attached to said anchoring surface.

17. The lockable anchor system of claim 16 wherein said fixed object is a real estate for sale sign; further wherein,
said rotary arm anchor attaches to said sign and said anchoring surface, and
said real estate for sale sign attaches to said anchoring surface.

18. The lockable anchor system of claim 1 wherein said lockable anchor system is capable of securing one or more target objects by locking said target objects to said lockable anchor system.

19. The lockable anchor system of claim 1 wherein:
said interior end, said horizontal connectors, and said exterior end are made of a single piece of bent metal; and,
said interior end attaches to a first horizontal connector, said first horizontal connector connects to said exterior end, said exterior end connects to a second horizontal connector, and said second horizontal connector is welded back to said interior end.

20. A lockable anchor method comprising:
inserting a stake of a rotary arm anchor having said stake and an arm into an anchoring surface;
holding said rotary arm anchor to said anchoring surface with a helical portion of said stake having a shaft and a helical portion;
receiving a lock near an exterior end of said arm having an interior end and said exterior end;
attaching said stake to said arm at a second end of said stake and said interior end of said arm; and
preventing a rotary motion at said interior end by holding said exterior end to a fixed object with said lock; wherein,
inserting said stake into said anchoring surface comprises
aligning a first end of stake with an anchoring location in said anchoring surface,
pressing said first end into said anchoring surface, and
rotating said rotary arm anchor about a rotary axis with a rotary motion.
